(19) United States
(12) Patent Application Publication
(10) Pub. No.: US 2023/0183501 A1
(43) Pub. Date: Jun. 15, 2023

(54) INK, CONTAINER, PRINTING DEVICE, METHOD OF PRINTING, AND PRINTED MATTER

(71) Applicants: Shin HASEGAWA, Tokyo (JP); Takashi TAMAI, Kanagawa (JP); Michihiko NAMBA, Kanagawa (JP); Yuta NAKAMURA, Kanagawa (JP); Mayumi YOSHIHARA, Kanagawa (JP); Daiki HASEBE, Tokyo (JP)

(72) Inventors: Shin HASEGAWA, Tokyo (JP); Takashi TAMAI, Kanagawa (JP); Michihiko NAMBA, Kanagawa (JP); Yuta NAKAMURA, Kanagawa (JP); Mayumi YOSHIHARA, Kanagawa (JP); Daiki HASEBE, Tokyo (JP)

(21) Appl. No.: 17/974,548

(22) Filed: Oct. 27, 2022

(30) Foreign Application Priority Data
Dec. 10, 2021 (JP) 2021-200795

(51) Int. Cl. C09D 11/107; C09D 11/102; C09D 11/037; C09D 11/033; B41M 5/00

(52) U.S. Cl. CPC C09D 11/107; C09D 11/102; C09D 11/037; C09D 11/033; B41M 5/0023; B41M 5/0047; B41M 5/0058; B41M 5/0064; B41M 5/007

(57) ABSTRACT

An ink contains water, a coloring material, a resin, two or more types of organic solvents, and a surfactant, wherein the ink is horizontally discharged to a substrate.

### CROSS-REFERENCE TO RELATED APPLICATIONS

This patent application is based on and claims priority pursuant to 35 U.S.C. § 119 to Japanese Patent Application No. 2021-200795, filed on Dec. 10, 2021, in the Japan Patent Office, the entire disclosures of which is hereby incorporated by reference herein.

### BACKGROUND

### Technical Field

The present disclosure is related to an ink, a container, a printing device, a method of printing, and printed matter.

### Description of the Related Art

Ink for use in inkjet printing contains a humectant containing an organic solvent having a high boiling point for maintaining moisture. Such ink may produce images with defects such as beading and bleeding depending on the proportions of components in the ink and the type of a substrate.

### SUMMARY

According to embodiments of the present disclosure, an ink is provided which contains water, a coloring material, a resin, two or more types of organic solvents, and a surfactant, wherein the ink is horizontally discharged to a substrate.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a printing device according to an embodiment of the present disclosure;

FIG. 2 is a diagram illustrating a perspective view of a tank of a printing device;

FIG. 3 is a schematic diagram illustrating a liquid discharging device according to an embodiment of the present disclosure; and

FIG. 4 is a schematic diagram illustrating a liquid discharging device according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, an ink is provided which minimizes liquid dripping at ink discharging to a substrate in the horizontal direction and has excellent discharging stability, storage stability, attachability, and color development.

Ink

The ink of the present disclosure contains water, a coloring material, a resin, two or more types of organic solvents, a surfactant, and other optional components. The ink is used in a printing method of discharging the ink in a horizontal direction to a substrate.

Discharging ink in a horizontal direction typically invites liquid dripping, causing degradation of the discharging stability and requiring pre-processing of aqueous pre-coating liquid, which lowers the productivity.

Unlike such ink, the ink of the present disclosure, which contains water, a coloring material, a resin, two or more types of organic solvents, a surfactant, enhances the anti-liquid dripping and discharging stability. The ink also achieves excellent storage stability, attachability, and color development.

Organic Solvent

The ink of the present disclosure contains two or more types of organic solvents, preferably three or more, and more preferably, four or more. The two or more types of organic solvent in the ink enhance one or more properties of anti-liquid dripping, discharging stability, saturation and density of yellow, magenta, cyan, and black (YMCK) images, white image density or whiteness, attachability, and ink storage stability as compared with typical ink.

The two or more types of organic solvents preferably include 3-ethyl-3-hydroxymethyl oxetane. Inclusion of 3-ethyl-3-hydroxymethyl oxetane enhances the saturation, density, and attachability of YMCK images.

The two or more types of organic solvents include an organic solvent having a boiling point of from 100 to less than 140 degrees C. and an organic solvent having a boiling point of from 140 to 180 degrees C. in terms of the discharging stability, liquid dripping, and storage stability.

Specific examples of the organic solvent having a boiling point of 100 to less than 140 degrees C. include, but are not limited to, 1-methoxy-2-propanol (boiling point of 120 degrees C.), 1-ethoxy-2-propanol (boiling point of 133 degrees C.), ethylene glycol monomethyl ether (boiling point of 124 degrees C.), 2-methyl-2-butanol (boiling point of 102 degrees C.), and 3-methyl-1-butanol (boiling point of 131 degrees C.).

Specific examples of the organic solvent having a boiling point of 140 to 180 degrees C. include, but are not limited to, 1-butoxy-2-propanol (boiling point of 170 degrees C.), ethylene glycol monoethyl ether acetate (boiling point of 156 degrees C.), ethylene glycol monobutyl ether (boiling point of 172 degrees C.), and ethylene glycol monomethyl ether acetate (boiling point of 145 degrees C.).

The two or more types of organic solvents preferably contain an organic solvent having a vapor pressure of from 0.1 to less than 4 mmHg at 25 degrees C. and an organic solvent having a vapor pressure of from 4 to 15 mmHg at 25 degrees C. to achieve a good discharging stability, liquid dripping, and ink storage stability.

Specific examples of the organic solvent having a vapor pressure of from 0.1 to less than 4 mmHg at 25 degrees C. include, but are not limited to, 3-ethyl-3-hydroxymethyloxetane (vapor pressure of 1.0 mmHg at 25 degrees C.), 1-butoxy-2-propanol (vapor pressure of 1.40 mmHg at 25 degrees C.), ethylene glycol monoethyletheracetate ((vapor pressure of 2.34 mmHg at 25 degrees C.), 1-ethoxy-2-propanol (vapor pressure of 3.86 mmHg at 25 degrees C.), and dipropylene glycol monomethyl ether (vapor pressure of 0.38 mmHg at 25 degrees C.).

Specific examples of the organic solvent having a vapor pressure of from 4 to 15 mmHg at 25 degrees C. include, but are not limited to, 1-methoxy-2-propanol (vapor pressure of 12.5 mmHg at 25 degrees C.), propylene glycol monomethyl ether, and ethylene glycol monomethyl ether.

The organic solvent is preferably a water-soluble organic solvent. Examples of the water-soluble organic solvent include, but are not limited to, polyols, ethers such as polyol alkylethers and polyol arylethers, nitrogen-containing heterocyclic compounds, amides, amines, and sulfur-containing compounds.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, triethylene glycol, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide. N,N-dimethylformamide, 3-methoxy-N,N-dimethyl propioneamide, and 3-butoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate, 3-ethyl-3-hydroxymethyloxetane, 1-methoxy-2-propanol, 1-butoxy-2-propanol, and 1-ethoxy-2-propanol.

Of the organic solvents, a water-soluble organic solvent organic solvent having a boiling point of 250 degrees C. or lower is preferable to impart a good drying property in addition to serving as humectant.

Methyl alcohol, ethyl alcohol, n-propyl alcohol, and isopropyl alcohol are used as saturated monohydric alcohol having 1 to 3 carbon atoms to dry quickly.

Polyol compounds having eight or more carbon atoms and glycol ether compounds are also suitable.

Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

A polyol compound having eight or more carbon atoms and a glycol ether compound enhance permeability of ink for paper used as a substrate.

The proportion of the organic solvent to an entire ink is not particularly limited and can be suitably selected to suit to a particular application. For example, the proportion is preferably from 10 to 60 percent by mass and more preferably from 20 to 60 percent by mass.

Coloring Material

The coloring material has no particular limit and includes a substance such as a pigment or a dye.

The pigment includes an inorganic pigment or organic pigment. These can be used alone or in combination. Also, mixed crystals are usable as the pigments.

Examples of the pigments include, but are not limited to, black pigments, yellow pigments, magenta pigments, cyan pigments, white pigments, green pigments, orange pigments, and gloss or metallic pigments of gold, silver, and others.

Specific examples of the inorganic pigment include, but are not limited to, carbon black manufactured by known methods such as a contact method, furnace method, and thermal method, in addition to titanium oxide, iron oxide, calcium oxide, barium sulfate, aluminum hydroxide, barium yellow, cadmium red, and chrome yellow.

Specific examples of organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments having good affinity with solvents are preferable. Hollow resin particles and hollow inorganic particles can also be used.

The black pigment includes carbon black. Specific examples of carbon black include, but are not limited to, products manufactured by Mitsubishi Chemical Corporation such as #10B. #30, #33, #40, #44, #45, #45L, #50, #55, #95, #260, #900, #1000, #2200B, #2300, #2350, #2400B, #2650, #2700, #4000B, CF9, MA8, MA11, MA77, MA100, MA220, MA230, MA600, and MCF88; products manufactured by Cabot Corporation such as MONARCH 120, MONARCH 700, MONARCH 800, MONARCH 880, MONARCH 1000, MONARCH 1100, MONARCH 1300, MONARCH 1400, REGAL L, REGAL 99R, REGAL 250R, REGAL 300R, REGAL 330R, REGAL 400R, REGAL 500R, AND REGAL 660R; and products manufactured by Evonik Degusa Japan, Co., Ltd such as PRINTEX A. PRINTEX G, PRINTEX U, PRINTEX V, PRINTEX 55, PRINTEX 140U, PRINTEX 140V, SPECIAL BLACK 4, SPECIAL BLACK 4A, SPECIAL BLACK 5, SPECIAL BLACK 6, SPECIAL BLACK 100, SPECIAL BLACK 250. COLOR BLACK FW1, COLOR BLACK FW2, COLOR BLACK FW2V, COLOR BLACK FW18, COLOR BLACK FW200, COLOR BLACK S150, COLOR BLACK S160, and Color BLACK S170.

The white pigment has no specific limit and can be suitably selected to suit to a particular application. Specific examples include, but are not limited to, oxides, nitrides, oxynitride of titanium, silicon, aluminum, zirconium, and strontium. Of these, titanium oxide is preferable because it has a high refractive index and is little colored.

The number average primary particle diameter of titanium dioxide is preferably from 150 to 300 nm. A number average primary particle diameter of titanium dioxide of 150 nm or more imparts a high concealing property. A number average primary particle diameter of titanium dioxide is 300 nm or less enhances the dispersion and sedimentation of an ink.

Specific examples of the magenta pigment include, but are not limited to, Pigment Red 5, Pigment Red 7, Pigment Red 12, Pigment Red 48 (Ca), Pigment Red 48 (Mn), Pigment Red 57 (Ca), Pigment Red 57:1, Pigment Red 112, Pigment Red 122, Pigment Red 123, Pigment Red 168. Pigment Red 184, Pigment Red 202, and Pigment Violet 19.

Specific examples of the magenta pigment include, but are not limited to, Pigment Blue 1, Pigment Blue 2, Pigment Blue 3, Pigment Blue 15, Pigment Blue 15:3, Pigment Blue 15:4, Pigment Blue 16, Pigment Blue 22, Pigment Blue 60, Vat Blue 4, and Vat Blue 60.

Specific examples of the yellow pigments include, but are not limited to, Pigment Yellow 1, Pigment Yellow 2, Pigment Yellow 3, Pigment Yellow 12, Pigment Yellow 13, Pigment Yellow 14. Pigment Yellow 16, Pigment Yellow 17, Pigment Yellow 73, Pigment Yellow 74, Pigment Yellow 75, Pigment Yellow 83, Pigment Yellow 93, Pigment Yellow 95, Pigment Yellow 97, Pigment Yellow 98, Pigment Yellow 110, Pigment Yellow 114, Pigment Yellow 120, Pigment Yellow 128, Pigment Yellow 129, Pigment Yellow 138, Pigment Yellow 150, Pigment Yellow 151. Pigment Yellow 154, Pigment Yellow 155, and Pigment Yellow 180.

Of these, a combination of a yellow pigment of C.I.Pigment Yellow 110, 74, or 155, a magenta pigment of C.I.Pigment Red 122 or C.I.Pigment Violet 19, a cyan pigment of C.I.Pigment Blue 15:3, or a black pigment of C.I.Pigment black 7, or a white pigment of C.I.Pigment White 6 enhances the weather resistance, abrasion resistance, color development, color reproducibility in a high saturation and luminance red range of a printed image, and the discharging stability.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142. C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material is preferably from 0.1 to 15 percent by mass and more preferably from 1 to 10 percent by mass to the entire of white ink to enhance the image density, fixability, and discharging stability.

The coloring material preferably contains a pigment dispersion obtained by dispersing with a surfactant or a pigment dispersion covered with a polymer.

The surfactant for dispersing a black or white coloring material can be suitably selected in accordance with the type of a pigment.

Examples include, but are not limited to, anionic surfactants selected from the group consisting of alkylsulfonates, alkylbenzenesulfonates, alkylnaphthalenesulfonates, sodium naphthalenesulfonate-formalin condensates, alkane, olefin sulfonates, alkylsulfates, polyoxyethylene alkyl or alkylaryl ether sulfates, alkylphosphates, alkyldiphenyletherdisulfonates, ether carboxylates, alkylsulfosuccinates, α-sulfo aliphatic acid esters, and aliphatic acid salts, condensates of higher aliphatic acid and amino acids, and naphthenates.

Of these, aromatic sulfonates such as sodium naphthalene sulfonate formalin condensate are preferable in terms of the compatibility with carbon black about dispersibility and the foamability of a surfactant.

The aromatic sulfonate is obtained by introducing a sulfonic acid into an aromatic compound followed by neutralizing with a basic compound.

Specific examples include, but are not limited to, those obtained by neutralizing benzenesulfonate, p-toluenesulfonic acid, naphthalenesulfonic acid, alkylnaphthalenesulfonic acid with an alkylamine such as butylamine and triethylamine, an alkanolamine such as monoethanolamine, diethanolamine, triethanolamine, and triisopropanolamine, morpholine, ammonia water, sodium hydroxide, lithium hydroxide, potassium hydroxide, aminomethylpropanediol, aminoethylpropanediol and choline.

As the basic compound, a buffering agent such as tris(hydroxymethyl)aminomethane or Good's buffers may be used. Substances obtained by condensing an aromatic sulfonate with formalin can also be used. The sodium naphthalene sulfonate formalin condensate is a condensate of sodium naphthalene sulfonate and formaldehyde, and is not particularly limited as long as the condensate is formed by repeating the above-mentioned condensates.

The dispersant for use in the coloring material mentioned above can be suitably selected in accordance with the type of a pigment.

Specific examples of the polymer include, but are not limited to, polyamide, polyurethane, polyester, polyurea, epoxy resins, polycarbonate, urea resins, melamine resins, phenol resins, polysaccharides, gelatine, gum arabic, dextran, casein, protein, natural rubber, carboxy polymethylene, polyvinyl alcohol, polyvinyl pyrrolidone, polyvinyl acetate, polyvinyl chloride, polyvinylidene chloride, cellulose, ethyl cellulose, methyl cellulose, nitro cellulose, hydroxyethyl cellulose, cellulose acetate, polyethylene, polystyrene, polymers or copolymers of (meth)acrylic acid, polymers or copolymers of (meth)acrylic acid esters, copolymers of (meth)acrylic acids-(meth)acrylic acid esters, copolymers of styrene-maleic acid, sodium alginate, aliphatic acid, paraffin, bee wax, water wax, hardened beef tallow, carnauba wax, and albumin.

Of these, organic polymers having an anionic group such as a carboxylic acid group or sulfonic acid group can be used.

Specific examples of the nonionic organic polymer include, but are not limited to, polyvinyl alcohol or a saponified compound, polyethylene glycol monomethacrylate, polypropylene glycol monomethacyrlate, methoxypolyethylene glycol monomethacrylate, (co)polymers thereof, and cation ring-open polymers of 2-oxazoline. Completely saponified polyvinyl alcohol is little soluble in water. It is in fact little soluble in cold water but readily soluble in hot water, which is particularly preferable.

A dispersant for use in yellow, magenta, or cyan coloring material can be suitably selected depending on the type of an organic pigment.

Specific examples of the non-ionic surface active agents include, but are not limited to, polyoxyethylene alkyl ethers such as polyoxyethylene lauryl ether, polyoxyethylene myristyl ether, polyoxyethylene cetyl ether, polyoxyethylene stearyl ether, and poly oxyethylene oleyl ether; polyoxyethylene alkylphenyl ether such as polyoxyethylene octyl phenyl ether and polyoxyethylene nonyl phenyl ether; polyoxyethylene-α-naphthyl ether, polyoxyethylene-β-naphthyl ether, polyoxyethylene monostyryl phenyl ether, polyoxyethylene distyryl phenyl ether, polyoxyethylene alkyl naphthyl ether, polyoxyethylene monostyryl naphthyl ether, polyoxyethylene distyryl naphthyl ether, and a block copolymer of polyoxyethylene and polyoxy propylene.

The dispersant for use in a coloring material of yellow, magenta, or cyan is not particularly limited and can be suitably selected to suit to a particular application. For example, the compound represented by the following Chemical Formula 1 is preferable. When the compound represented by Chemical Formula 1 is used as dispersant, a color pigment ink having a small average particle diameter and a small standard deviation in particle size distribution can be obtained.

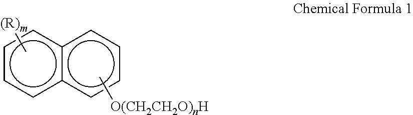

In Chemical Formula 1, R represents an alkyl group having 1 to 20 carbon atoms, aralkyl group having 1 to 20 carbon atoms, or ally group having 1 to 20 carbon atoms, m represents 0 or an integer of from 1 to 7, and n represents an integer of from 20 to 200.

In the compound represented by Chemical Formula 1, n is preferably from 20 to 100 and more preferably from 30 to 50. When n is less than 20, the dispersion stability is likely to deteriorate so that an ink obtained has a large average particle size and a large standard deviation in particle size distribution. Thus, the ink does not have satisfactory saturation. Conversely, when n exceeds 100, the viscosity tends to be high, which makes inkjet printing difficult. Of these, POE (n=40) βnaphthyl ether is particularly preferable.

Resin

The type of the resin has no particular limit and can be suitably selected to suit to a particular application. Examples include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins. These resin particles can be used alone or in combination. Of these, anionic self-emulsifying polyurethane resins, acrylic styrene-based resins, and acrylic silicone-based resins are preferable.

Resin particles formed of these resins may be used. It is possible to obtain an ink by mixing a resin emulsion in which such resin particles are dispersed in water as a dispersion medium with materials such as a coloring material and an organic solvent. The resin particle can be synthesized or procured.

The volume average particle diameter (mean volume diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve a good fixability and image robustness.

The mean volume diameter can be measured by using an instrument such as a particle size analyzer (Nanotrac Wave-UT151, manufactured by MicrotracBEL Corp.).

The proportion of the resin is not particularly limited and can be suitably selected to suit to a particular application. It is preferably from 1 to 30 percent by mass and more preferably from 5 to 20 percent by mass of the total mass of the ink to secure the fixability and storage stability of an entire ink.

The particle diameter of the solid portion in an ink has no particular limit and can be selected to suit to a particular application. The maximum frequency of the particle diameter of the solid portion in the ink is preferably from 20 to 1000 nm and more preferably from 20 to 150 nm in the maximum number conversion to enhance discharging stability and image quality such as image density. The solid content includes particles such as resin particles and pigment particles. The particle diameter can be measured by using a particle size analyzer (Nanotrac Wave-UT151, manufactured by MicrotracBEL Corp).

Surfactant

The surfactant is not particularly limited. Specific examples include, but are not limited to, silicone-based surfactants, fluorochemical surfactants, acetylene glycol-based surfactants, nonionic surfactants, anionic surfactants, and amphoteric surfactants.

The silicone-based surfactant is not particularly limited and can be suitably selected to suit to a particular application. The silicone-based surfactants not decomposed even in a high pH environment are preferable. The silicone-based surfactants include, for example, side chain-modified polydimethyl siloxane, both distal end-modified polydimethyl siloxane, one distal end-modified polydimethyl siloxane, and side chain both distal end-modified polydimethyl siloxane. As the modification group, it is particularly preferable to select a polyoxyethylene group or polyoxyethylene polyoxypropylene group because these demonstrate good properties as aqueous surfactants. The silicone-based surfactant can be a polyether-modified silicone-based surfactant. One of the surfactants is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid. Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

The silicone-based surfactant has no particular limit and can be suitably selected to suit to a particular application.

Specific examples include, but are not limited to, side-chain-modified polydimethyl siloxane, both end-modified polydimethyl siloxane, one-end-modified polydimethyl siloxane, and side-chain-both-end-modified polydimethyl siloxane. A polyether-modified silicone-based surfactant having a polyoxyethylene group or a polyoxyethylene polyoxypropylene group is particularly preferable because such a surfactant demonstrates good property as an aqueous surfactant.

Such surfactants can be synthesized or procured. Products can be procured from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

The polyether-modified silicon-based surfactant has no particular limit and can be suitably selected to suit to a particular application. For example, a compound is usable in which the polyalkylene oxide structure represented by the following Chemical Formula S-1 is introduced into the side chain of the Si site of dimethyl polysiloxane.

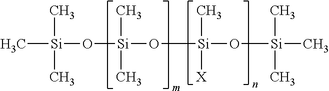

X=—R(C₂H₄O)ₐ(C₃H₆O)_{b}R′ Chemical Formula S-1

In Chemical Formula S-1, m, n, a, and b each, respectively represent integers, R represents an alkylene group, and R′ represents an alkyl group.

Specific examples of the polyether-modified silicone-based surfactant include, but are not limited to, KF-618, KF-642, and KF-643 (all manufactured by Shin-Etsu Chemical Co., Ltd.). EMALEX-SS-5602 and SS-1906EX (both manufactured by NIHON EMULSION Co., Ltd.). FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Toshiba Silicone Co. Ltd.).

As the fluorochemical surfactant, a compound in which the number of carbon atoms replaced with fluorine atoms is from 2 to 16 is preferable and, from 4 to 16, more preferable.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain.

Of these, polyoxyalkylene ether polymer compounds having a perfluoroalkyl ether group in its side chain are preferable because these do not readily foam and the fluorochemical surfactant represented by the following Chemical Formula F-1 or Chemical Formula F-2 is preferable.

CF₃CF₂(CF₂CF₂)ₘ—CH₂CH₂O(CH₂CH₂O)ₙH Chemical Formula F-1

In the compound represented by Chemical Formula F-1, m is preferably 0 or an integer of from 1 to 10 and n is preferably 0 or an integer of from 1 to 40.

CₙF₂ₙ₊₁—CH₂CH(OH)CH₂—O—(CH₂CH₂O)ₐ—Y Chemical Formula F-2

In the compound represented by the Chemical Formula F-2, Y represents H or CₘF₂ₘ₊₁, where n represents an integer of from 1 to 6, or CH₂CH(OH)CH₂—CₘF₂ₘ₊₁, where m represents an integer of from 4 to 6, or CₚH₂ₚ₊₁, where p represents an integer of from 1 to 19. n represents an integer of from 1 to 6. a represents an integer of from 4 to 14.

The fluorochemical surfactant can be procured. Specific examples of the product include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED). POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™, DSN-403N (manufactured by DAIKIN INDUSTRIES, Ltd.) are particularly preferable.

The proportion of the surfactant in an ink is not particularly limited and it can be suitably selected to suit a particular application. It is preferably from 0.001 to 5 percent by mass and more preferably from 0.05 percent by mass to 5 percent by mass to achieve good wettability and discharging stability and enhance the image quality.

Water

As water, pure water and hyper pure water such as deionized water, ultrafiltered water, reverse osmosis water, and distilled water can be used.

The proportion of the water to the entire of an ink is not particularly limited and can be suitably selected to suit to a particular application. It is preferably from 10 to 90 percent by mass, more preferably from 30 to 90 percent by mass, and particularly preferably from 50 to 90 percent by mass.

Other Components

As the other components, known additives can be used, including foam inhibitors or defoaming agents, pH regulators, preservatives and fungicides, and corrosion inhibitors.

Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

Preservatives and Fungicides

The preservatives and fungicides are not particularly limited. One specific example is 1,2-benzisothiazoline-3-one.

Corrosion Inhibitor

The corrosion inhibitor has no particular limit. Specific examples include, but are not limited to, acid sulfites and sodium thiosulfates.

pH Regulator

The pH regulator has no particular limit as long as it can control pH to 7 or greater. It includes, but are not limited to, amines such as diethanol amine and triethanol amine.

Ink Properties

The properties of ink are not particularly limited and can be suitably selected to suit to a particular application. Properties such as viscosity, surface tension, particle size, and pH are preferably in the following ranges.

The ink preferably has a viscosity of from 1.0 to 30 mPa·s and more preferably from 1.5 to 20 mPa·s at 25 degrees C. to enhance the print density, text quality, and dischargeability. Viscosity can be measured by an instrument such as a rotatory viscometer (RE-80L, manufactured by TOKI SANGYO CO., LTD.). The measuring conditions are as follows:

Standard cone rotor (1° 34′× R24)

Sample liquid amount: 1.2 mL

Rate of rotation: 50 rotations per minute (rpm)

25 degrees C.

Measuring time: three minutes.

The surface tension of the ink is preferably 30 mN/m or less and more preferably 25 mN/m or less at 25 degrees C. to quickly dry the ink by suitably leveling the ink on a substrate.

pH of the ink is preferably from 7 to 12 and more preferably from 8 to 11 to prevent corrosion of metal material in contact with liquid.

Set of Ink and Processing Fluid

A combination of the ink of the present embodiment and a processing fluid may be used as an ink set. The processing fluid contains an flocculant that aggregates components contained in the ink. The components contained in the ink include the coloring material. This aggregation of ink enhances the image density of an image formed with the ink.

Processing Fluid

The processing fluid contains a flocculant and other optional components such as an organic solvent and water. The descriptions of the organic solvent, water, and the other components are omitted because the same components as those for the processing fluid can be used.

Flocculant

The flocculant is not particularly limited as long as it can aggregate components in an ink. One of such flocculants is a metal salt. Metal salts associate with the coloring material in an ink by an electric charge action and form an aggregate with the coloring material. Then the salt separates the coloring material from the liquid phase to promote the attachment onto a substrate. In addition, inclusion of a metal salt in the processing fluid reduces beading even on a substrate having a low ink absorption property, resulting in forming quality images.

The metal salt has no specific limit and can be suitably selected to suit to a particular application. Examples are salts of titanium compounds, chromium compounds, copper compounds, cobalt compounds, strontium compounds, barium compounds, iron compounds, aluminum compounds, calcium compounds, magnesium compounds, zinc compounds, and nickel compounds. These can be used alone or in combination. Of these, salts of calcium compounds, magnesium compounds, and nickel compounds are preferable and alkali earth metal salts of calcium and magnesium are more preferable to effectively aggregate a coloring material such as a pigment.

Of these ionic metal salts are preferable. Magnesium salts are particularly preferable.

The magnesium compound is not particularly limited and can be suitably selected to suit to a particular application.

Specific examples include, but are not limited to, magnesium chloride, magnesium acetate, magnesium sulfate, magnesium nitrate, and magnesium silicate.

The calcium compound is not particularly limited and can be suitably selected to suit to a particular application.

Specific examples include, but are not limited to, calcium carbonate, calcium nitrate, calcium chlorinate, calcium acetate, calcium sulfate, and calcium silicate.

The barium compound is not particularly limited and can be suitably selected to suit to a particular application. One of such barium compounds is barium sulfate.

The zinc compound has no specific limit and is suitably selected to a particular application. Specific examples include, but are not limited to, zinc sulfate and zinc carbonate.

The aluminum compound has no specific limit and is suitably selected to suit to a particular application. Specific examples include, but are not limited to, aluminum silicate and aluminum hydroxide.

The proportion of a metal salt to the processing fluid is preferably from 0.85 to 1.4 mol/kg. A proportion of 0.85 mol/kg reduces beading even on a substrate having a low ink absorption property, resulting in forming quality images. A proportion of 1.4 mol/kg enhances the storage stability of a processing fluid.

Substrate

The substrate refers to an object to which the ink of the present disclosure is applied and can be temporarily or permanently attached.

The substrate is not particularly limited and can be suitably selected to suit to a particular application regarding shape, structure, and material.

The material of a substrate includes metal, glass, synthetic paper, resin, and ceramics.

The substrate includes: plastic sheet made of a basic material such as polyethylene terephthalate, polycarbonate, polypropylene, polyethylene, polysulfone, ABS resin, and polyvinylchloride; a surface of metal such as brass, iron, aluminum, stainless steel, and copper, or a non-metal substance coated with metal by a method such as deposition; synthetic paper made of a paper substrate treated with water-repelling; and so-called ceramics and glass, manufactured by sintering an inorganic material at a high temperature. Of these, metal and glass are preferable.

The size of the substrate mentioned above is not particularly limited and can be suitably selected to suit to a particular application.

The direction of discharging the ink mentioned above is not particularly limited and can be suitably selected to suit to a particular application. It is preferable to discharge the ink in a horizontal direction.

Container

The container of the present disclosure includes an ink container containing the ink of the present disclosure and other optional members.

What the container is made of is not particularly limited and can be suitably selected to suit to a particular application. One of such materials is polyethylene terephthalate.

The size, structure, and shape are not particularly limited and can be suitably selected to suit to a particular application.

Method of Printing and Printing Device

The ink of the present disclosure can be suitably applied to a printing device employing inkjet printing, such as a printer, facsimile machine, photocopier, multifunction peripheral (serving as a printer, a facsimile machine, and a photocopier), and solid freeform fabrication device such as a 3D printer and additive manufacturing device.

In the present disclosure, the printing device and the method of printing respectively represent a device capable of discharging liquids such as ink and processing fluids to a substrate and a method of printing utilizing the device.

The printing device may furthermore optionally include a device relating to feeding, conveying, and ejecting a substrate and other devices referred to as a pre-processing device and a post-processing device in addition to the head portion for discharging an ink.

The printing device and the method of printing may furthermore optionally include a heating device for use in the heating and a drying device for use in the drying. The heating device and the drying device may optionally heat and dry the print surface and the opposite surface of a substrate. The heating device and the drying device are not particularly limited. For example, a fan heater and an infra-red heater can be used. Heating and drying can be conducted before, in the middle of, or after printing.

In addition, the printing device and the method of printing are not limited to those producing meaningful visible images such as text and figures with the ink. They include a method of printing and a printing device capable of producing patterns like geometric design and 3D images.

In addition, the printing device includes both a serial type device in which the liquid discharging head moves and a line type device in which the liquid discharging head is not moved, unless otherwise specified.

Furthermore, in addition to the desktop type, this printing device includes a device capable of printing images on a wide printing medium having, for example, AO size, and a continuous printer capable of using continuous paper rolled up in a roll-like form as a printing medium.

As an example of the pre-processing device and the post-processing device, like the ink of black (K), cyan (C), magenta (M), and yellow (Y) ink, the pre-processing device and the post-processing device may further include a liquid accommodating unit including a pre-processing liquid or a post-processing liquid and a liquid discharging head to discharge the pre-processing liquid or the post-processing liquid according to an inkjet printing method.

As another example of the pre-processing device and the post-processing device, it is suitable to dispose a pre-processing device and a post-processing device not employing the inkjet printing method but a blade coating method, a roll coating method, or a spray coating method.

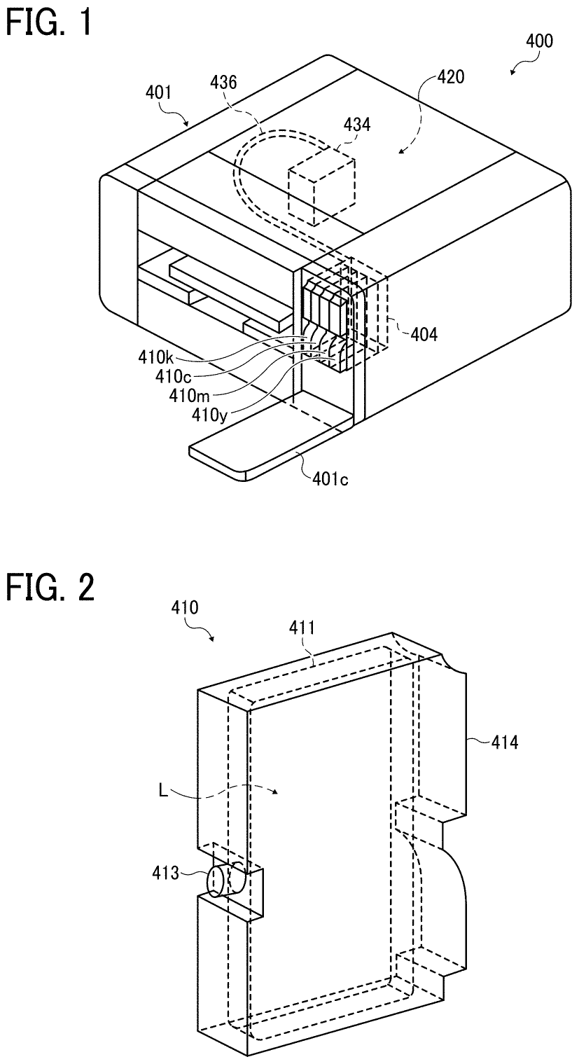

The printing device is described using an example with reference to FIG. 1 and FIG. 2. FIG. 1 is a diagram illustrating a perspective view of a printing device. FIG. 2 is a diagram illustrating a perspective view of a tank in a printing device. An image forming device 400, which is an embodiment of the printing device, is a serial type image forming device. The image forming device 400 includes a mechanical unit 420 in an exterior 401. Each ink accommodating unit (ink container) 411 of each tank 410 (410k, 410c, 410m, and 410y) for each color of black (K), cyan (C), magenta (M), and yellow (Y) is made of, for example, packaging material such as aluminum laminate film. The ink accommodating unit 411 is housed in, for example, a plastic container housing unit (container) 414 and L represents liquid contained in the ink accommodating unit 411. The tank 410 is used as an ink cartridge of each color.

A cartridge holder 404 is disposed on the rear side of the opening appearing when a cover 401c is opened. The tank 410 is detachably attached to the cartridge holder 404. In this configuration, each ink discharging outlet 413 of the tank 410 communicates with a discharging head 434 for each color via a supplying tube 436 for each color and the ink can be discharged from the discharging head 434 to a substrate.

The inkjet printing device in the specification of the present disclosure refers to a liquid discharging device capable of discharging liquid such as the ink of the present disclosure and the processing fluid onto a substrate.

An embodiment of the liquid discharging head as the inkjet printing device is described with reference to the drawings. The present disclosure are not limited to those.

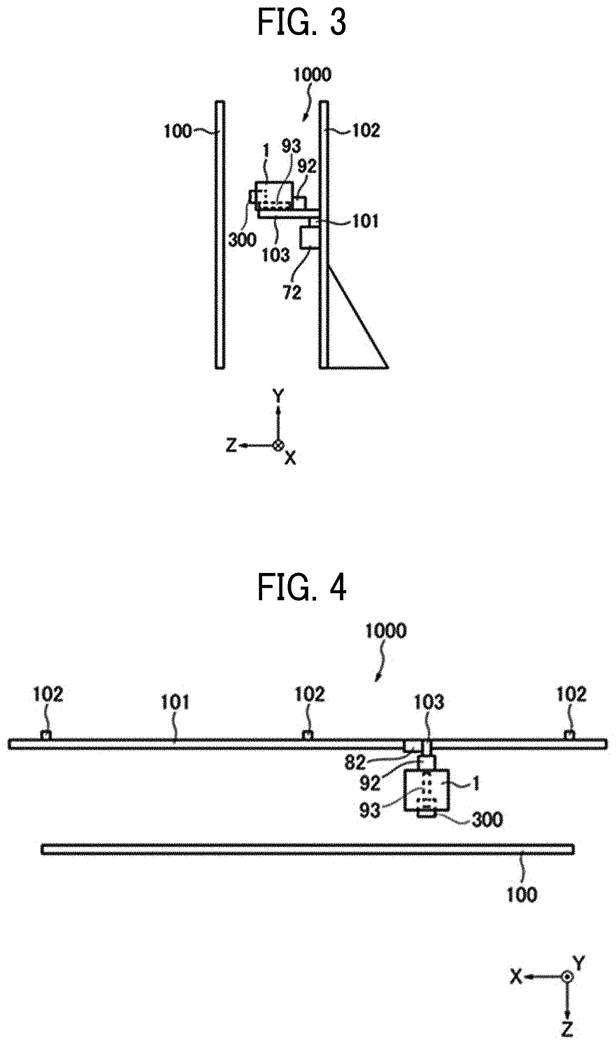

FIG. 3 is a diagram illustrating a side view of the liquid discharging device and FIG. 4 is a diagram illustrating a plan view of the liquid discharging device.

A liquid discharging device 1000 is disposed facing a substrate 100. A carriage 1 carries ahead 300 for discharging ink as an example of liquid towards the substrate 100. AZ axis rail 103 holds the carriage 1 movable in the Z axis direction.

An X axis rail 101 holds the Z axis rail 103 that carriage 1 movable in the X axis direction. A Y axis rail 102 holds the X axis rail 101 movable in the Y axis direction. The X axis is an example of the first axis, the Y axis is an example of second axis that intersects the first axis, and the Z axis is the third axis that intersects the first axis and the second axis. The carriage 1 is an example of the liquid discharging unit and the head 300 is an example of the liquid discharging head.

The liquid discharging device 1000 includes a Z axis direction driving unit 92 that moves the carriage 1 in the Z axis direction along the Z axis rail 103 and an X axis direction driving unit 72 that moves the Z axis rail 103 in the X axis direction along the X axis rail 101. Moreover, the liquid discharging device 1000 includes a Y axis direction driving unit 82 that moves the X axis rail 101 in the Y axis direction along the Y axis rail 102. The Z axis direction driving unit 92 is an example of the first driving unit and moves the carriage 1 to the Z axis direction that intersects the X axis and the Y axis. The carriage 1 and the head 300 do not necessarily move along the Z axis direction but may move diagonally as long as the movement includes the Z axis direction component.

The carriage 1 includes another Z axis direction driving unit 93. The Z axis direction driving unit 93 is an example of the second driving unit and moves the head 300 to the Z axis direction against the carriage 1.

The liquid discharging device 1000 configured as described above discharges ink from the head 300 to the substrate 100 and forms an image on the substrate 100 while moving the carriage 1 in the X axis direction, Y axis direction, and Z axis direction. The substrate 100 is illustrated as a flat plate. It can be a plane nearly vertically disposed or a plane having a large curvature like those of a vehicle, truck, or aircraft.

Printed Matter

The printed matter of the present disclosure has a substrate and a printing layer formed on the substrate with the printing device of the present disclosure.

The material of the substrate includes metal, glass, synthetic paper, resin, and ceramics.

Terms such as image forming, recording, printing, and print used in the present disclosure represent the same meaning.

Also, recording media, media, and (print) substrates in the present disclosure have the same meaning unless otherwise specified.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

### Manufacturing Example 1 of Pigment Dispersion

Manufacturing Black Pigment Dispersion A of Surfactant Type

Recipe

Pigment: C.I.Pigment Black 7 (NIPEX 150, gas black, manufactured by Degusa-Huls AG): 200 parts

A sodium naphthalene sulfonate formalin condensate (Pionin A-45-PN, manufactured by TAKEMOTO OIL & FAT CO., LTD., total content of naphthalene sulfonate dimer, trimer, and tetramer of 30 percent by mass: 50 parts

Distilled water: 750 parts

The mixture of the components mentioned above was premixed followed by dispersing for 15 minutes at a liquid temperature of 30 degrees C. with 0.03 mm zirconia beads (density: 6.03×10⁻⁶ g/m²) using a bead mill disperser (UAM-015, manufactured by KOTOBUKI KOGYO CO., LTD.) at a peripheral speed of 10 m/s. The coarse particles were separated from the resulting dispersion with a centrifuge (Model-3600, manufactured by Kubota Corporation) to obtain Black Pigment Dispersion A (solid content of 20 percent by mass) having an average particle diameter of 110 nm.

### Manufacturing Example 2 of Pigment Dispersion

Manufacturing Black Pigment Dispersion B of Polymer Coating Type

After sufficient replacement with nitrogen gas in a flask equipped with a mechanical stirrer, a thermometer, a nitrogen gas introducing tube, a reflux tube, and a dripping funnel, 11.2 g of styrene, 2.8 g of acrylic acid, 12.0 g of lauryl methacrylate, 4.0 g of polyethlene glycol methacrylate, 4.0 g of styrene macromer (AS-6, manufactured by TOA GOSEI CO., LTD.), and 0.4 g of mercapto ethanol were charged in the flask, followed by heating to 65 degrees C. Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer (AS-6, manufactured by TOA GOSEI CO., LTD.), 3.6 g of mercapto ethanol, 2.4 g of azobismethyl valeronitrile, and 18 g of methylethyl ketone was added dropwise to the flask over two and a half hours. Subsequently, a liquid mixture of 0.8 g of azobismethyl valeronitrile and 18 g of methylethyl ketone was added dropwise to the flask in half an hour. Subsequent to one-hour aging at 65 degrees C., 0.8 g of azobisdimethyl valeronitrile was added followed by furthermore one-hour aging. After the reaction, 364 g of methylethyl ketone was added to the flask to prepare 800 g of a polymer solution having a concentration of 50 percent by mass.

A total of 28 g of the thus-obtained polymer solution, 26 g of C.I.Pigment Black 7 (NIPEX 150, gas black, manufactured by Degusa-Huls AG.), 13.6 g of 1 mol/L potassium hydroxide solution, 20 g of methylethyl ketone, and 30 g of deionized water were sufficiently stirred and the resulting mixture was mixed and kneaded using a triple roll mill. The thus-obtained paste was placed in 200 g of deionized water followed by stirring. Then methylethyl ketone and water were distilled away using an evaporator. After pre-mixing, the mixture was dispersed for 15 minutes at a liquid temperature of 30 degrees C. with 0.03 mm zirconia beads (density: 6.03×10⁻⁶ g/m²) using a bead mill disperser (UAM-015, manufactured by KOTOBUKI KOGYO CO., LTD.) at a peripheral speed of 10 m/s.

The coarse particles were separated from the resulting dispersion with a centrifuge (Model-3600, manufactured by Kubota Corporation) to obtain Black Pigment Dispersion B (solid content of 20 percent by mass) of polymer coating type having an average particle diameter of 125 nm.

### Manufacturing Example 3 of Pigment Dispersion

Manufacturing Cyan Pigment Dispersion C of Surfactant Type

Recipe

Pigment: C.I.Pigment Blue 15:3 (Cyanine Blue A-385, manufactured by Dainichiseika Color & Chemicals Mfg. Co., Ltd.): 200 parts

Compound (n=40) represented by the following Chemical Formula: 56 parts

Chemical Formula 5

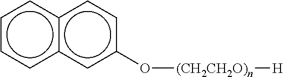

Pionin A-51-B (manufactured by TAKEMOTO OIL & FAT CO., LTD.): 2.5 parts

Distilled water: 742 parts

The mixture specified above was premixed and dispersed by a bead mill disperser (UAM-015, manufactured by KOTOBUKI KOGYO CO., LTD.) using zirconia beads having a diameter of 0.03 mm (density of 6.03×10⁻⁶ g/cm²) at a peripheral speed of 10 m/s at a liquid temperature of 30 degrees C. for 15 minutes. The coarse particles were separated from the resulting dispersion with a centrifuge (Model-3600, manufactured by KUBOTA Corporation) to obtain Cyan Pigment Dispersion C (solid portion of 20 percent by mass) of surfactant type having an average particle diameter of 80 nm.

### Manufacturing Example 4 of Pigment Dispersion

Manufacturing Cyan Pigment Dispersion D of Polymer Coating Type

After sufficient replacement with nitrogen gas in a flask equipped with a mechanical stirrer, a thermometer, a nitrogen gas introducing tube, a reflux tube, and a dripping funnel, 11.2 g of styrene, 2.8 g of acrylic acid, 12.0 g of lauryl methacrylate, 4.0 g of polyethlene glycol methacrylate, 4.0 g of styrene macromer (AS-6, manufactured by TOA GOSEI CO., LTD.), and 0.4 g of mercapto ethanol were charged in the flask, followed by heating to 65 degrees C. Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer (AS-6, manufactured by TOA GOSEI CO., LTD.), 3.6 g of mercapto ethanol, 2.4 g of azobismethyl valeronitrile, and 18 g of methylethyl ketone was added dropwise to the flask over two and a half hours. Subsequently, a liquid mixture of 0.8 g of azobismethyl valeronitrile and 18 g of methylethyl ketone was added dropwise to the flask in half an hour. Subsequent to one-hour aging at 65 degrees C., 0.8 g of azobisdimethyl valeronitrile was added followed by furthermore one-hour aging. After the reaction, 364 g of methylethyl ketone was added to the flask to prepare 800 g of a polymer solution having a concentration of 50 percent by mass.

A total of 28 g of the thus-obtained polymer solution, 26 g of C.I.Pigment Blue 15:3 (Cyanine Blue-A-385, manufactured by Dainichiseika Color & Chemicals Mfg. Co., Ltd.), 13.6 g of 1 mol/L potassium hydroxide solution, 20 g of methylethyl ketone, and 30 g of deionized water were sufficiently stirred and the obtained mixture was mixed and kneaded using a triple roll mill. The thus-obtained paste was placed in 200 g of deionized water followed by stirring. Then methyl ethyl ketone and water were distilled away using an evaporator. After pre-mixing, the mixture was dispersed for 15 minutes at a liquid temperature of 30 degrees C. with 0.03 mm zirconia beads (density: 6.03×10⁻⁶ g/m²) using a bead mill disperser (UAM-015, manufactured by KOTOBUKI KOGYO CO., LTD.) at a peripheral speed of 10 m/s.

The coarse particles were separated from the resulting dispersion with a centrifuge (Model-3600, manufactured by Kubota Corporation) to obtain Cyan Pigment Dispersion D (solid content of 20 percent by mass) of polymer coating type having an average particle diameter of 100 nm.

### Manufacturing Example 5 of Pigment Dispersion

Manufacturing Magenta Pigment Dispersion E of Surfactant Type

Recipe

C.I.Pigment Red 122, Cromophtal JET magenta DMQ, manufactured by Ciba Specialty Chemicals: 200 parts

Compound (n=40) represented by the following Chemical Formula: 56 parts

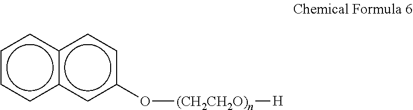

Distilled water: 744 parts

The mixture specified above was premixed and dispersed by a bead mill disperser (UAM-015, manufactured by KOTOBUKI KOGYO CO., LTD.) using zirconia beads having a diameter of 0.03 mm (density of 6.03×10⁻⁶ g/cm²) at a peripheral speed of 10 m/s at a liquid temperature of 30 degrees C. for 15 minutes. The coarse particles were separated from the resulting dispersion with a centrifuge (Model-3600, manufactured by KUBOTA Corporation) to obtain Magenta Pigment Dispersion C (solid portion of 20 percent by mass) of surfactant type having an average particle diameter of 120 nm.

### Manufacturing Example 6 of Pigment Dispersion

Manufacturing Magenta Pigment Dispersion F of Polymer Coating Type

After sufficient replacement with nitrogen gas in a flask equipped with a mechanical stirrer, a thermometer, a nitrogen gas introducing tube, a reflux tube, and a dripping funnel, 11.2 g of styrene, 2.8 g of acrylic acid, 12.0 g of lauryl methacrylate, 4.0 g of polyethlene glycol methacrylate, 4.0 g of styrene macromer (AS-6, manufactured by TOA GOSEI CO., LTD.), and 0.4 g of mercapto ethanol were charged in the flask, followed by heating to 65 degrees C. Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer (AS-6, manufactured by TOA GOSEI CO., LTD.), 3.6 g of mercapto ethanol, 2.4 g of azobismethyl valeronitrile, and 18 g of methylethyl ketone was added dropwise to the flask over two and a half hours. Subsequently, a liquid mixture of 0.8 g of azobismethyl valeronitrile and 18 g of methylethyl ketone was added dropwise to the flask in half an hour. Subsequent to one-hour aging at 65 degrees C., 0.8 g of azobisdimethyl valeronitrile was added followed by furthermore one-hour aging. After the reaction, 364 g of methylethyl ketone was added to the flask to prepare 800 g of a polymer solution having a concentration of 50 percent by mass.

A total of 28 g of the thus-obtained polymer solution, 26 g of C.I.Pigment Red 122 (Cromophtal JET Magenta DMQ, manufactured by Ciba Specialty Chemicals), 13.6 g of 1 mol/L potassium hydroxide solution, 20 g of methylethyl ketone, and 30 g of deionized water were sufficiently stirred and the obtained mixture was mixed and kneaded using a triple roll mill. The thus-obtained paste was placed in 200 g of deionized water followed by stirring. Then methyl ethyl ketone and water were distilled away using an evaporator. After pre-mixing, the mixture was dispersed for 15 minutes at a liquid temperature of 30 degrees C. with 0.03 mm zirconia beads (density: 6.03×10⁻⁶ g/m²) using a bead mill disperser (UAM-015, manufactured by KOTOBUKI KOGYO CO., LTD.) at a peripheral speed of 10 m/s.

The coarse particles were separated from the resulting dispersion with a centrifuge (Model-3600, manufactured by Kubota Corporation) to obtain Magenta Pigment Dispersion F (solid content of 20 percent by mass) of polymer coating type having an average particle diameter of 100 nm.

### Manufacturing Example 7 of Pigment Dispersion

Manufacturing Yellow Pigment Dispersion G of Surfactant Type

Recipe

C.I.Pigment Yellow 110. Corimax Yellow 3RL, manufactured by ZEYA CHEMICALS (HAIMEN) Co., Ltd.: 200 parts

Compound (n=40) represented by the following Chemical Formula: 56 parts

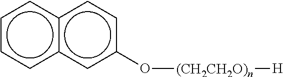

Distilled water: 744 parts

The mixture specified above was premixed and dispersed by a bead mill disperser (UAM-015, manufactured by KOTOBUKI KOGYO CO., LTD.) using zirconia beads having a diameter of 0.03 mm (density of 6.03×10⁻⁶ g/cm²) at a peripheral speed of 10 m/s at a liquid temperature of 30 degrees C. for 15 minutes. The coarse particles were separated from the resulting dispersion with a centrifugal (Model-3600, manufactured by KUBOTA Corporation) to obtain Yellow Pigment Dispersion G (solid portion of 20 percent by mass) of surfactant type having an average particle diameter of 90 nm.

### Manufacturing Example 8 of Pigment Dispersion

Manufacturing Yellow Pigment Dispersion H of Polymer Coating Type

After sufficient replacement with nitrogen gas in a flask equipped with a mechanical stirrer, a thermometer, a nitrogen gas introducing tube, a reflux tube, and a dripping funnel, 11.2 g of styrene, 2.8 g of acrylic acid, 12.0 g of lauryl methacrylate, 4.0 g of polyethlene glycol methacrylate, 4.0 g of styrene macromer (AS-6, manufactured by TOA GOSEI CO., LTD.), and 0.4 g of mercapto ethanol were charged in the flask, followed by heating to 65 degrees C. Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer (AS-6, manufactured by TOA GOSEI CO., LTD.), 3.6 g of mercapto ethanol, 2.4 g of azobismethyl valeronitrile, and 18 g of methylethyl ketone was added dropwise to the flask over two and a half hours. Subsequently, a liquid mixture of 0.8 g of azobismethyl valeronitrile and 18 g of methylethyl ketone was added dropwise to the flask in half an hour. Subsequent to one-hour aging at 65 degrees C., 0.8 g of azobisdimethyl valeronitrile was added followed by furthermore one-hour aging. After the reaction, 364 g of methylethyl ketone was added to the flask to prepare 800 g of a polymer solution having a concentration of 50 percent by mass.

A total of 28 g of the thus-obtained polymer solution, 26 g of C.I.Pigment Yellow 110 (Corimax Yellow 3RL, manufactured by ZEYA CHEMICALS (HAIMEN) Co., Ltd.), 13.6 g of 1 mol/L potassium hydroxide solution, 20 g of methylethyl ketone, and 30 g of deionized water were sufficiently stirred and the obtained mixture was mixed and kneaded using a triple roll mill. The thus-obtained paste was placed in 200 g of deionized water followed by stirring. Then methylethyl ketone and water were distilled away using an evaporator. After pre-mixing, the mixture was dispersed for 15 minutes at a liquid temperature of 30 degrees C. with 0.03 mm zirconia beads (density: 6.03×10⁻⁶ g/m²) using a bead mill disperser (UAM-015, manufactured by KOTOBUKI KOGYO CO., LTD.) at a peripheral speed of 10 m/s.

The coarse particles were separated from the resulting dispersion with a centrifuge (Model-3600, manufactured by Kubota Corporation) to obtain Yellow Pigment Dispersion H (solid content of 20 percent by mass) of polymer coating type having an average particle diameter of 100 nm.

### Manufacturing Example 9 of Pigment Dispersion

Manufacturing White Pigment Dispersion I of Surfactant Type

Recipe

C.I.Pigment White 6 (JR-403, number average primary particle diameter of 250 nm, aspect ratio of 2, surface treated with AL and Si, manufactured by TAYCA CORPORATION): 200 parts

Pigment Disperser (TEGO Dispers 651, manufactured by Evonik Industries AG): 56 parts

Distilled water: 744 parts

The mixture specified above was premixed and dispersed by a bead mill disperser (UAM-015, manufactured by KOTOBUKI KOGYO CO., LTD.) using zirconia beads having a diameter of 0.03 mm (density of 6.03×10⁻⁶ g/cm²) at a peripheral speed of 10 m/s at a liquid temperature of 30 degrees C. for 15 minutes. The coarse particles were separated from the resulting dispersion with a centrifuge (Model-3600, manufactured by KUBOTA Corporation) to obtain White Pigment Dispersion I (solid portion of 20 percent by mass) of surfactant type having an average particle diameter of 250 nm.

### Manufacturing Example 10 of Pigment Dispersion

Manufacturing Yellow Pigment Dispersion J of Surfactant Type

Yellow Pigment Dispersion J (solid content of 20 percent by mass) of surfactant type was obtained in the same manner as in Manufacturing Example 7 of the pigment dispersion except that C.I.Pigment Yellow 110 (Corimax Yellow 3RL, manufactured by ZEYA CHEMICALS (HAIMEN) Co., Ltd.) was replaced with C.I.Pigment Yellow 74 (Fast Yellow 531, manufactured by Dainichiseika Color & Chemicals Mfg. Co., Ltd.).

### Manufacturing Example 11 of Pigment Dispersion

Manufacturing Yellow Pigment Dispersion K of Polymer Coating Type

Yellow Pigment Dispersion K (solid content of 20 percent by mass) of polymer coating type was obtained in the same manner as in Manufacturing Example 8 of the pigment dispersion except that C.I.Pigment Yellow 110 (Corimax Yellow 3RL, manufactured by ZEYA CHEMICALS (HAIMEN) Co., Ltd.) was replaced with C.I.Pigment Yellow 74 (Fast Yellow 531, manufactured by Dainichiseika Color & Chemicals Mfg. Co., Ltd.).

### Manufacturing Example 12 of Pigment Dispersion

Manufacturing Yellow Pigment Dispersion L of Surfactant Type

Yellow Pigment Dispersion L (solid content of 20 percent by mass) of surfactant type was obtained in the same manner as in Manufacturing Example 7 of the pigment dispersion except that C.I.Pigment Yellow 110 (Corimax Yellow 3RL, manufactured by ZEYA CHEMICALS (HAIMEN) Co., Ltd.) was replaced with C.I.Pigment Yellow 155 (INK JET YELLOW 4G VP2532, manufactured by Clariant (Japan) K.K.).

### Manufacturing Example 13 of Pigment Dispersion

Manufacturing Yellow Pigment Dispersion M of Polymer Coating Type

Yellow Pigment Dispersion M (solid content of 20 percent by mass) of surfactant type was obtained in the same manner as in Manufacturing Example 8 of the pigment dispersion except that C.I.Pigment Yellow 110 (Corimax Yellow 3RL, manufactured by ZEYA CHEMICALS (HAIMEN) Co., Ltd.) was replaced with C.I.Pigment Yellow 155 (INK JET YELLOW 4G VP2532, manufactured by Clariant (Japan) K.K.).

### Manufacturing Example 14 of Pigment Dispersion

Manufacturing Magenta Pigment Dispersion N of Surfactant Type

Magenta Pigment Dispersion N (Solid Content of 20 Percent by Mass) of Surfactant Type was obtained in the same manner as in Manufacturing Example 5 of the pigment dispersion except that C.I.Pigment Red 122 (Cromophtal JET Magenta DMQ, manufactured by Ciba Specialty Chemicals) was replaced with C.I.Pigment Violet 19 (INK JET Magenta E5B02VP2984, manufactured by Clariant (Japan) K.K.).

### Manufacturing Example 15 of Pigment Dispersion

Manufacturing Magenta Pigment Dispersion O of Polymer Coating Type

Magenta Pigment Dispersion O (solid content of 20 percent by mass) of surfactant type was obtained in the same manner as in Manufacturing Example 6 of the pigment dispersion except that C.I.Pigment Red 122 (Cromophtal JET Magenta DMQ, manufactured by Ciba Specialty Chemicals) was replaced with C.I.Pigment Violet 19 (INK JET Magenta E5V02VP2984, manufactured by Clariant (Japan) K.K.).

### Examples 1 to 16 and Comparative Examples 1 to 5

Preparation of Ink

The materials of the prescriptions shown in the following Tables 1 to 4 are mixed and stirred. The mixture was filtered with a polypropylene filter having an average pore diameter of 0.8 μm to obtain the inks of Examples 1 to 16 and Comparative Examples 1 to 5. The proportion of each component shown in Tables 1 to 4 are represented in percent by mass.

TABLE 1

| | | Example | | | | | |
|---|---|---|---|---|---|---|---|
| | | 1 | 2 | 3 | 4 | 5 | 6 |
| Pigment | Black Pigment | 5.0 | — | — | — | — | — |
| | Dispersion A | | | | | | |
| | Black Pigment | 5.0 | — | — | — | — | — |
| | Dispersion B | | | | | | |
| | Cyan Pigment | — | 5.0 | — | — | — | — |
| | Dispersion C | | | | | | |
| | Cyan Pigment | — | 5.0 | — | — | — | — |
| | Dispersion D | | | | | | |
| | Magenta Pigment | — | — | 5.0 | — | — | — |
| | Dispersion E | | | | | | |
| | Magenta Pigment | — | — | 5.0 | — | — | — |
| | Dispersion F | | | | | | |
| | Yellow Pigment | — | — | — | 5.0 | — | — |
| | Dispersion G | | | | | | |
| | Yellow Pigment | — | — | — | 5.0 | — | — |
| | Dispersion H | | | | | | |
| | White Pigment | — | — | — | — | 50.0 | — |
| | Dispersion I | | | | | | |
| | Yellow Pigment | — | — | — | — | — | 5.0 |
| | Dispersion J | | | | | | |
| | Yellow Pigment | — | — | — | — | — | 5.0 |
| | Dispersion K | | | | | | |
| | Yellow Pigment | — | — | — | — | — | — |
| | Dispersion L | | | | | | |
| | Yellow Pigment | — | — | — | — | — | — |
| | Dispersion M | | | | | | |
| | Magenta Pigment | — | — | — | — | — | — |
| | Dispersion N | | | | | | |
| | Magenta Pigment | — | — | — | — | — | — |
| | Dispersion O | | | | | | |
| Organic solvent | Ethanol | 5.0 | 5.0 | 5.0 | 5.0 | 5.0 | 5.0 |
| | 3-ethyl-3-hydroxymethyl | 5.0 | 5.0 | 5.0 | 5.0 | 5.0 | 5.0 |
| | oxetane | | | | | | |
| | 1-methoxy-2-propanol | 10.0 | 10.0 | 10.0 | 10.0 | 10.0 | 10.0 |
| | 1-butoxy-2-propanol | 10.0 | 10.0 | 10.0 | 10.0 | 10.0 | 10.0 |
| | 1-ethoxy-2-propanol | — | — | — | — | — | — |
| | Ethylene glycol | — | — | — | — | — | — |
| | monoethyl ether acetate | | | | | | |
| Surfactant | Surfactant α | 0.3 | 0.3 | 0.3 | 0.3 | 0.3 | 0.3 |
| | Surfactant β | 0.3 | 0.3 | 0.3 | 0.3 | 0.3 | 0.3 |
| Resin | Resin a | 6.6 | 6.6 | 6.6 | 6.6 | 6.6 | 6.6 |
| | Resin b | 5.6 | 5.6 | 5.6 | 5.6 | 5.6 | 5.6 |
| | Resin c | — | — | — | — | — | — |
| Preservatives | PROXEL LV | 0.2 | 0.2 | 0.2 | 0.2 | 0.2 | 0.2 |
| and fungicides | | | | | | | |
| pH regulator | 2-amino-2-ethyl- | 0.3 | 0.3 | 0.3 | 0.3 | 0.3 | 0.3 |
| | 1,3-propane diol | | | | | | |
| Water | Highly pure water | Balance | Balance | Balance | Balance | Balance | Balance |

| | | | | | | |
|---|---|---|---|---|---|---|
| Total (percent by mass) | 100 | 100 | 100 | 100 | 100 | 100 |

TABLE 2

| | | Example | | | | | |
|---|---|---|---|---|---|---|---|
| | | 7 | 8 | 9 | 10 | 11 | 12 |
| Pigment | Black Pigment | — | — | 5.0 | — | — | — |
| | Dispersion A | | | | | | |
| | Black Pigment | — | — | 5.0 | — | — | — |
| | Dispersion B | | | | | | |
| | Cyan Pigment | — | — | — | 5.0 | — | — |
| | Dispersion C | | | | | | |
| | Cyan Pigment | — | — | — | 5.0 | — | — |
| | Dispersion D | | | | | | |
| | Magenta Pigment | — | — | — | — | 5.0 | — |
| | Dispersion E | | | | | | |
| | Magenta Pigment | — | — | — | — | 5.0 | — |
| | Dispersion F | | | | | | |
| | Yellow Pigment | — | — | — | — | — | 5.0 |
| | Dispersion G | | | | | | |
| | Yellow Pigment | — | — | — | — | — | 5.0 |
| | Dispersion H | | | | | | |
| | White Pigment | — | — | — | — | — | — |
| | Dispersion I | | | | | | |
| | Yellow Pigment | — | — | — | — | — | — |
| | Dispersion J | | | | | | |
| | Yellow Pigment | — | — | — | — | — | — |
| | Dispersion K | | | | | | |
| | Yellow Pigment | 5.0 | — | — | — | — | — |
| | Dispersion L | | | | | | |
| | Yellow Pigment | 5.0 | — | — | — | — | — |
| | Dispersion M | | | | | | |
| | Magenta Pigment | — | 5.0 | — | — | — | — |
| | Dispersion N | | | | | | |
| | Magenta Pigment | — | 5.0 | — | — | — | — |
| | Dispersion O | | | | | | |
| Organic solvent | Ethanol | 5.0 | 5.0 | 5.0 | 5.0 | 5.0 | 5.0 |
| | 3-ethyl-3-hydroxymethyl | 5.0 | 5.0 | — | 5.0 | 5.0 | 5.0 |
| | oxetane | | | | | | |
| | 1-methoxy-2-propanol | 10.0 | 10.0 | 10.0 | 20.0 | — | 10.0 |
| | 1-butoxy-2-propanol | 10.0 | 10.0 | 10.0 | — | 20.0 | — |
| | 1-ethoxy-2-propanol | — | — | — | — | — | — |
| | Ethylene glycol | — | — | — | — | — | 10.0 |
| | monoethyl ether acetate | | | | | | |
| Surfactant | Surfactant α | 0.3 | 0.3 | 0.3 | 0.3 | 0.3 | 0.3 |
| | Surfactant β | 0.3 | 0.3 | 0.3 | 0.3 | 0.3 | 0.3 |
| Resin | Resin a | 6.6 | 6.6 | 6.6 | 6.6 | 6.6 | 6.6 |
| | Resin b | 5.6 | 5.6 | 5.6 | 5.6 | 5.6 | 5.6 |
| | Resin c | — | — | — | — | — | — |
| Preservatives | PROXEL LV | 0.2 | 0.2 | 0.2 | 0.2 | 0.2 | 0.2 |
| and fungicides | | | | | | | |
| pH regulator | 2-amino-2-ethyl- | 0.3 | 0.3 | 0.3 | 0.3 | 0.3 | 0.3 |
| | 1,3-propane diol | | | | | | |
| Water | Highly pure water | Balance | Balance | Balance | Balance | Balance | Balance |

| | | | | | | |
|---|---|---|---|---|---|---|
| Total (percent by mass) | 100 | 100 | 100 | 100 | 100 | 100 |

TABLE 3

| | | Example | | | |
|---|---|---|---|---|---|
| | | 13 | 14 | 15 | 16 |
| Pigment | Black Pigment Dispersion A | — | — | — | 5.0 |
| | Biack Pigment Dispersion B | — | — | — | 5.0 |
| | Cyan Pigment Dispersion C | — | — | — | — |
| | Cyan Pigment Dispersion D | — | — | — | — |
| | Magenta Pigment Dispersion E | — | — | — | — |
| | Magenta Pigment Dispersion F | — | — | — | — |
| | Yellow Pigment Dispersion G | — | — | — | — |
| | Yellow Pigment Dispersion H | — | — | — | — |
| | White Pigment Dispersion I | — | — | — | — |
| | Yellow Pigment Dispersion J | 5.0 | — | — | — |
| | Yellow Pigment Dispersion K | 5.0 | — | — | — |
| | Yellow Pigment Dispersion L | — | 5.0 | — | — |
| | Yellow Pigment Dispersion M | — | 5.0 | — | — |
| | Magenta Pigment Dispersion N | — | — | 5.0 | — |
| | Magenta Pigment Dispersion O | — | — | 5.0 | — |
| Organic | Ethanol | 5.0 | 5.0 | 5.0 | 5.0 |
| solvent | 3-ethyl-3-hydroxymethyl | 5.0 | 5.0 | 5.0 | 5.0 |
| | oxetane | | | | |
| | 1-methoxy-2-propanol | — | 10.0 | 10.0 | 10.0 |
| | 1-butoxy-2-propanol | 10.0 | 10.0 | 10.0 | 10.0 |
| | 1-ethoxy-2-propanol | 10.0 | — | — | — |
| | Ethylene glycol monoethyl | — | — | — | — |
| | ether acetate | | | | |
| Surfactant | Surfactant α | 0.3 | 0.3 | 0.3 | 0.3 |
| | Surfactant β | 0.3 | 0.3 | 0.3 | 0.3 |
| Resin | Resin a | 6.6 | — | 6.6 | 6.6 |
| | Resin b | 5.6 | 5.6 | — | — |
| | Resin c | — | — | — | 5.6 |
| Preservatives | PROXEL LV | 0.2 | 0.2 | 0.2 | 0.2 |
| and | | | | | |
| fungicides | | | | | |
| pH regulator | 2-amino-2-ethyl-1,3-propane | 0.3 | 0.3 | 0.3 | 0.3 |
| | diol | | | | |
| Water | Highly pure water | Balance | Balance | Balance | Balance |

| | | | | |
|---|---|---|---|---|
| Total (percent by mass) | 100 | 100 | 100 | 100 |

TABLE 4

| | | Comparative Example | | | | |
|---|---|---|---|---|---|---|
| | | 1 | 2 | 3 | 4 | 5 |
| Pigment | Biack Pigment | 5.0 | — | — | — | — |
| | Dispersion A | | | | | |
| | Black Pigment | 5.0 | — | — | — | — |
| | Dispersion B | | | | | |
| | Cyan Pigment | — | 5.0 | — | — | — |
| | Dispersion C | | | | | |
| | Cyan Pigment | — | 5.0 | — | — | — |
| | Dispersion D | | | | | |
| | Magenta Pigment | — | — | 5.0 | — | — |
| | Dispersion E | | | | | |
| | Magenta Pigment | — | — | 5.0 | — | — |
| | Dispersion F | | | | | |
| | Yellow Pigment | — | — | — | 5.0 | — |
| | Dispersion G | | | | | |
| | Yellow Pigment | — | — | — | 5.0 | — |
| | Dispersion H | | | | | |
| | White Pigment | — | — | — | — | 50.0 |
| | Dispersion I | | | | | |
| | Yellow Pigment | — | — | — | — | — |
| | Dispersion J | | | | | |
| | Yellow Pigment | — | — | — | — | — |
| | Dispersion K | | | | | |
| | Yellow Pigment | — | — | — | — | — |
| | Dispersion L | | | | | |
| | Yellow Pigment | — | — | — | — | — |
| | Dispersion M | | | | | |
| | Magenta Pigment | — | — | — | — | — |
| | Dispersion N | | | | | |
| | Magenta Pigment | — | — | — | — | — |
| | Dispersion O | | | | | |
| Organic solvent | Ethanol | 30.0 | — | 30.0 | — | 30.0 |
| | 3-ethyl-3-hydroxymethyl | — | — | — | — | — |
| | oxetane | | | | | |
| | 1-methoxy-2-propanol | — | 30.0 | — | 30.0 | — |
| | 1-butoxy-2-propanol | — | — | — | — | — |
| | 1-ethoxy-2-propanol | — | — | — | — | — |
| | Ethylene glycol | — | — | — | — | — |
| | monoethyl ether acetate | | | | | |
| Surfactant | Surfactant α | 0.3 | 0.3 | 0.3 | 0.3 | 0.3 |
| | Surfactant β | 0.3 | 0.3 | 0.3 | 0.3 | 0.3 |
| Resin | Resin a | 6.6 | 6.6 | 6.6 | 6.6 | 6.6 |
| | Resin b | 5.6 | 5.6 | 5.6 | 5.6 | 5.6 |
| | Resin c | — | — | — | — | — |
| Preservatives | PROXEL LV | 0.2 | 0.2 | 0.2 | 0.2 | 0.2 |
| and fungicides | | | | | | |
| pH regulator | 2-amino-2-ethyl- | 0.3 | 0.3 | 0.3 | 0.3 | 0.3 |
| | 1,3-propane diol | | | | | |
| Water | Highly pure water | Balance | Balance | Balance | Balance | Balance |

| | | | | | |
|---|---|---|---|---|---|
| Total (percent by mass) | 100 | 100 | 100 | 100 | 100 |

The individual components in Tables 2 to 4 are detailed as follows.

Organic Solvent

Ethanol: Boiling point of 79 degrees C., vapor pressure of 59.3 mmHg at 25 degrees C.

3-ethyl-3-hydroxymethyl oxetane: boiling point of 203 degrees C., vapor pressure of 1.00 mmHg at 25 degrees C.

1-methoxy-2-propanol: boiling point of 120 degrees C., vapor pressure of 12.5 mmHg at 25 degrees C.

1-butoxy-2-propanol: boiling point of 170 degrees C., vapor pressure of 1.40 mmHg at 25 degrees C.

1-ethoxy-2-propanol: boiling point of 133 degrees C., vapor pressure of 3.86 mmHg at 25 degrees C.

Ethylene glycol monoethyl ether acetate: boiling point of 156 degrees C., vapor pressure of 2.34 mmHg at 25 degrees C.

Surfactant

Surfactant α: Triton HW-1000 (compound represented by the following Chemical Formula α, polyoxyalkylene alkyl ether, manufactured by The Dow Chemical Company

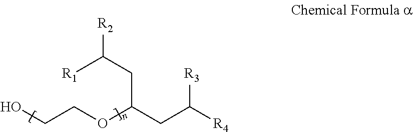

In Chemical Formula α, R₁, R₂, R₃, and R₄ each independently represent hydrogen atoms or alkyl groups having 1 to 5 carbon atoms. The alkyl group having 1 to 5 carbon atoms can be straight-chained or branch-chained. Specific examples include, but are not limited to, a methyl group, ethyl group, propyl group, isopropyl group, n-butyl group, s-butyl group, isobutyl group, t-butyl group, pentyl group, isopentyl group, and neopentyl group. In Chemical Formula α, n represents an integer of from 4 to 10.

Surfactant β: TEGO Wet 270 (silicone-based compound represented by the following Chemical Formula β, silicone-based surfactant, manufactured by Evonik Industries AG)

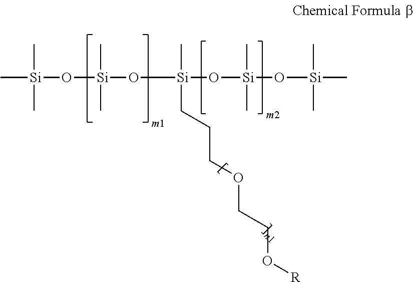

In Chemical Formula β, R represents a hydrogen atom or methyl group, m1 and m2 each independently represent 0 or integers of from 1 to 6, and n1 represents an integer of from 2 to 20.

Resin

Resin a: TakeLAC XW-75-W932 (anionic self emulsifying polyurethane resin, solid content of 28 percent by mass, manufactured by Mitsui Chemicals, Inc.)

Resin b: Mowinyl 5450 (styrene acrylic resin, solid content of 45 percent by mass, manufactured by The Nippon Synthetic Chemical Industry Co., Ltd.)

Resin c: TOCRYL W-6109 (acrylic silicone resin, solid content of 40 percent by mass, manufactured by TOYOCHEM CO., LTD.)

Preservatives and Fungicides

PROXEL LV, manufactured by AVECIA Inc.

The liquid dripping, discharging stability, saturation and density of YMCK image, white image density (whiteness), attachability, and ink storage stability of each ink obtained were evaluated. The results are shown in Tables 5 to 8.

Liquid Dripping

Using each ink of Examples and Comparative Examples loaded in the printer NNV 13, manufactured by Ricoh Digital Painting Co., Ltd., illustrated in FIGS. 3 and 4, solid images were printed on the entire of A4 size substrates A and B with a printing density of 105.8 dot per inch (dpi) and 2 passes. The amount of ink attached to the substrate was adjusted to 3.00 nL/dot. The image 10 minutes after the printing was evaluated on liquid dripping according to the following evaluation criteria. Grades A and B are allowable.

Substrate

Substrate A: Aluminum complex plate (EA440HA-X2, white, available from ESCO CO., LTD.)

Substrate B: Glass substrate (Optima Fine Wine Bottle, 500 cc, 10931/30, manufactured by AS ONE Corporation)

Evaluation Criteria

A: No liquid dripping
B: No liquid dripping but image is not even (liquid pool at the bottom of image)
C: Liquid dripped

Discharging Stability

Using the printer NNV 13, manufactured by Ricoh Digital Painting Co., Ltd., illustrated in FIGS. 3 and 4, a solid image with a width of 13,000 mm and a length of 3,250 mm was printed on the substrate A at 23 degrees C. and a relative humidity of 50 percent with a printing density of 105.8 dpi and 2 pass. The amount of ink attached to the substrate was adjusted to 3.00 nL/dot. The nozzle check pattern was printed after the printing and evaluated on the degree of misdirection according to the following evaluation criteria. Grades A and B are allowable.

Evaluation Criteria

A: No misdirection
B: One to three misdirections
C: Four or more misdirections

Saturation and Density of YMCK Image

The optical density (OD) of the same solid images of Examples and Comparative Examples as prepared in Liquid Dripping was measured with a spectrophotometer (X-Rite 938, manufactured by X-Rite Inc.) and evaluated according to the following evaluation criteria.

The vividness (i.e., saturation) of an image refers to the distance between the origin in the chromaticity diagram and a point plotted therein based on the measuring of the color of a solid image of the image sample printed on the substrates A and B with the spectrophotometer mentioned above. The saturation is represented by the value a and the value b in the chromaticity diagram obtained by the following relationship.

Saturation=\sqrt{(a*)²+(b*)²}

Evaluation Criteria Saturation of Yellow Pigment Ink

A: Saturation is 55 or greater
B: Saturation is from 50 to less than 55
C: Saturation is less than 50

Saturation of Magenta Pigment Ink

A: Saturation is 55 or greater
B: Saturation is from 50 to less than 55
C: Saturation is less than 50

Saturation of Cyan Pigment Ink

A: Saturation is 55 or greater
B: Saturation is from 50 to less than 55
C: Saturation is less than 50

Optical Density (OD) of Black Pigment Ink

### A: OD≥0.9

### B: 0.9>OD≥0.8

### C: 0.8>OD

White Image Density (Whiteness)

The optical density of the same solid images of Examples and Comparative Examples as prepared in Liquid Dripping was measured with a spectrophotometer (X-Rite 938, manufactured by X-Rite Inc.) and evaluated according to the following evaluation criteria.

The whiteness of an image refers to the distance between the origin in the chromaticity diagram and a point plotted therein based on measuring of the color of a solid image of the image sample printed on the substrates A and B with an Xrite densitometer. The whiteness is represented by the value a and the value b in the chromaticity diagram obtained by the following relationship.

Whiteness=\sqrt{(a*)²+(b*)²}

Evaluation Criteria

A: Whiteness is 3 or less
B: Whiteness is greater than 3 to 5
C: Whiteness is greater than 5

Attachability

The attachability of the same solid images of Examples and Comparative Examples as prepared in Liquid Dripping to the substrates A and B was evaluated by the following manners: (1) attaching transparent pressure-sensitive tape (hereinafter referred to as tape, cellulose tape CT-18, manufactured by Nichiban Co., Ltd.) onto the image and peeling off the tape from the substrates A and B; and (2) making a particular cut in the substrates according to the cross-cutting method described in JIS-5600-5-6 format.

The evaluation criteria on the test results of peeling-off tape are as follows;

a: image was not peeled off after attaching and peeling-off tape
c: image was partially peeled off after attaching and peeling-off tape

The evaluation criteria on the test result of the cross cut method of making particular cuts in 25 cells of 5×5 cells formed on the applied film was follows:

a: film was not peeled off after attaching and peeling-off tape
c: film was partially peeled off after attaching and peeling-off tape Slight peeling-off at a cut intersection was ignored because the degree of cut force strongly affects the intersection.

Based on the results, the attachability was evaluated according to the following evaluation criteria.

Evaluation Criteria

A: a for both tape peeling test and cross cut method
B: a for tape peeling and c for cross cut method or vice versa
C: c for both tape peeling test and cross cut method

Evaluation on Ink Storage Stability

Each ink was put in a polyethylene container and the container was sealed. The ink was stored at 70 degrees C. for two weeks. The volume average particle diameter, surface tension, and viscosity of the ink were measured before and after the storage. The change ratios of the measuring results were obtained to evaluate the ink storage stability according to the following criteria. The largest change ratio among those of the volume average particle diameter, surface tension, and viscosity was adopted for evaluation.

The viscosity of the ink was measured with a cone plate rotary viscometer. VISCOMETER TV-22, manufactured by TOKI SANGYO CO., LTD. at a rate of rotation of 50 rpm, a temperature of hemathermal circulating water at 25 degrees C., and a shearing speed of 191.4 sec⁻¹.

The surface tension of the ink was measured at 25 degrees C. using an automatic surface tensiometer (DY-300, manufactured by KYOWA INTERFACE SCIENCE Co., Ltd.).

The volume average particle diameter of the ink can be measured by using a particle size analyzer (Nanotrac Wave-UT151, manufactured by MicrotracBEL Corp.).

Evaluation Criteria

A: Change ratio was less than 10 percent
B: Change ratio was 10 to 50 percent
C: Change ratio surpasses 50 percent

TABLE 5

| | | Example | | | | | |
|---|---|---|---|---|---|---|---|
| | | 1 | 2 | 3 | 4 | 5 | 6 |
| Evaluation | Liquid dripping (substrate A) | A | A | A | A | A | A |
| result | Liquid dripping (substrate B) | A | A | A | A | A | A |
| | Discharging stability (substrate A) | A | A | A | A | A | A |
| | Saturation and density of YMCK Image | A | A | A | A | A | A |
| | (substrate A) | | | | | | |
| | Saturation and density of YMCK Image | A | A | A | A | A | A |
| | (substrate B) | | | | | | |
| | Density of white image (whiteness) | — | — | — | — | A | — |
| | (substrate A) | | | | | | |
| | Density of white image (whiteness) | — | — | — | — | A | — |
| | (substrate B) | | | | | | |
| | Attachability (substrate A) | A | A | A | A | A | A |
| | Attachability (substrate B) | A | A | A | A | A | A |
| | Storage stability of ink | A | A | A | A | A | A |

TABLE 6

| | | Example | | | | | |
|---|---|---|---|---|---|---|---|
| | | 7 | 8 | 9 | 10 | 11 | 12 |
| Evaluation | Liquid dripping (substrate A) | A | A | A | A | B | A |
| result | Liquid dripping (substrate B) | A | A | A | A | B | A |
| | Discharging stability (substrate A) | A | A | A | B | A | B |
| | Saturation and density of YMCK Image | A | A | B | A | A | A |
| | (substrate A) | | | | | | |
| | Saturation and density of YMCK Image | A | A | B | A | A | A |
| | (substrate B) | | | | | | |
| | Density of white image (whiteness) | — | — | — | — | — | — |
| | (substrate A) | | | | | | |
| | Density of white image (whiteness) | — | — | — | — | — | — |
| | (substrate B) | | | | | | |
| | Attachability (substrate A) | A | A | B | A | A | A |
| | Attachability (substrate B) | A | A | B | A | A | A |
| | Storage stability of ink | A | A | A | A | B | A |

TABLE 7

| | | Example | | | |
|---|---|---|---|---|---|
| | | 13 | 14 | 15 | 16 |
| Evaluation | Liquid dripping (substrate A) | B | A | A | A |
| result | Liquid dripping (substrate B) | B | A | A | A |
| | Discharging stability (substrate A) | A | A | A | A |
| | Saturation and density of YMCK image | A | A | A | A |
| | (substrate A) | | | | |
| | Saturation and density of YMCK image | A | A | A | A |
| | (substrate B) | | | | |
| | Density of white image (whiteness) | — | — | — | — |
| | (substrate A) | | | | |
| | Density of white image (whiteness) | — | — | — | — |
| | (substrate B) | | | | |
| | Attachability (substrate A) | A | B | B | A |
| | Attachability (substrate B) | A | B | B | A |
| | Storage stability of ink | B | A | A | A |

TABLE 8

| | | Comparative Example | | | | |
|---|---|---|---|---|---|---|
| | | 1 | 2 | 3 | 4 | 5 |
| Evaluation | Liquid dripping (substrate A) | B | B | B | B | B |
| Result | Liquid dripping (substrate B) | B | B | B | B | B |
| | Discharging stability (substrate A) | C | C | C | C | C |
| | Saturation and density of YMCK Image | B | B | B | B | B |
| | (substrate A) | | | | | |
| | Saturation and density of YMCK Image | B | B | B | B | B |
| | (substrate B) | | | | | |
| | Density of white image (whiteness) | — | — | — | — | — |
| | (substrate A) | | | | | |
| | Density of white image (whiteness) | — | — | — | — | — |
| | (substrate B) | | | | | |
| | Attachability (substrate A) | C | C | C | C | C |
| | Attachability (substrate B) | C | C | C | C | C |
| | Storage stability of ink | C | C | C | C | C |

As seen in the results shown in Tables 1 to 8, Examples 1 to 16 were better than Comparative Examples 1 to 5 with regard to at least one of evaluations on the liquid dripping, discharging stability, saturation and density of YMCK image, white image density (whiteness), attachability, and ink storage stability. The inks of Examples 1 to 15 containing two or more types of organic solvents account for this difference.

Example 1 is superior to Example 9 regarding the saturation and density of YMCK image and attachability, 3-ethyl-3-hydroxymethyl oxetane contained of Example 1 accounts for this result.

Example 2 is superior regarding the discharging stability and Example 3 is superior regarding the liquid dripping and ink storage stability to Examples 10 and 11. These differences lie on the organic solvent having a boiling point of 100 degrees C. to lower than 140 degrees C. and the organic solvent having a boiling point of 140 degrees C. to lower than 180 degrees C. of Examples 2 and 3.

Example 4 is superior regarding the discharging stability and Example 6 is superior regarding the liquid dripping and ink storage stability to Examples 12 and 13. These differences lie on the organic solvent having a vapor pressure of from 0.1 to less than 4 mmHg and the organic solvent having a vapor pressure of from 4 to 15 mmHg at 25 degrees C. of Examples 4 and 6.

Example 7 is superior to Examples 14 regarding the attachability. The anionic self-emulsifying polyurethane resin contained in Example 7 as a resin for ink for inkjet printing accounts for this result.

Example 8 is superior to Examples 15 regarding the attachability. The acrylic silicone-based resin or styrene acrylic resin furthermore contained in Example 8 as a resin for ink accounts for this evaluation.

Aspects of the present disclosure are, for example, as follows.

1. An ink contains water, a coloring material, a resin, two or more types of organic solvents, and a surfactant, wherein the ink is horizontally discharged to a substrate.

2. The ink according to 1 mentioned above, wherein the two or more types of the organic solvent are water-soluble organic solvent contains at least one of 1-methoxy-2-propanol, 1-ethoxy-2-propanol, ethylene glycol monomethyl ether, 2-methyl-2-butanol, or 3-methyl-1-butanol, 1-butoxy-2-propanol, ethylene glycol monoethyl ether acetate, ethylene glycol monobutyl ether, or ethylene glycol monomethyl ether acetate.

3. The ink according to 1 or 2 mentioned above, wherein the two or more types of organic solvents comprise 3-ethyl-3-hydroxymethyl oxetane.

4. The ink according to any one of 1 to 3 mentioned above, wherein the two or more types of organic solvent are water-soluble organic solvent comprising ethanol, 1-methoxy-2-propanol, 1-butoxy-2-propanol, and 3-ethyl-3-hydroxymethyl oxetane.

5. The ink according to any one of 1 to 4 mentioned above, wherein the two or more types of organic solvents comprise an organic solvent having a boiling point of from 100 to less than 140 degrees C. and an organic solvent having a boiling point of from 140 to 180 degrees C.

6. The ink according to any one of 1 to 5 mentioned above, wherein the two or more types of organic solvents contains an organic solvent having a vapor pressure of from 0.1 to less than 4 mmHg at 25 degrees C. and an organic solvent having a vapor pressure of from 4 to 15 mmHg at 25 degrees C.

7. The ink according to any one of 1 to 6 mentioned above, wherein the coloring material contains a yellow pigment of C.I.Pigment Yellow 110, 74, or 155, a magenta pigment of C.I.Pigment Red 122 or C.I.Pigment Violet 19, a cyan pigment of C.I.Pigment Blue 15:3, a black pigment of C.I.Pigment black 7, or a white pigment of C.I.Pigment White 6.

8. The ink according to any one of 1 to 7 mentioned above, wherein the resin contains an anionic self-emulsifying polyurethane resin.

9. The ink according to any one of 1 to 8 mentioned above, wherein the resin contains at least one of an acrylic silicone-based resin and a styrene acrylic resin.

10. The ink according to any one of 1 to 9 mentioned above, wherein the coloring material contains a pigment dispersion dispersed by a surfactant and a pigment dispersion covered by a polymer.

11. The ink according to any one of 1 to 10 mentioned above, wherein the surfactant contains at least one of a silicone-based surfactant and a nonionic surfactant.

12. A container contains an ink container containing the ink of any one of 1 to 11 mentioned above.

13. A printing device contains a container containing the ink of any one of 1 to 11 and

a discharging device for horizontally discharging the ink to the substrate.

14. A method of printing includes horizontally discharging the ink of any one of 1 to 11 mentioned above to the substrate and forming an image on the substrate with the ink attached to the substrate by the discharging.

15. The method according to any one of 1 to 11 mentioned above, wherein the substrate is made of at least one of metal, glass, synthetic paper, resin, or ceramics.

16. Printed matter comprising:

a substrate; and

a printing layer formed on the substrate by the ink of any one of 1 to 11 mentioned above attached to the substrate.

17. The printed matter according to 16 mentioned above, wherein the substrate is made of at least one of metal, glass, synthetic paper, resin, or ceramics.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An ink comprising:
water;
a coloring material;
a resin:
two or more types of organic solvents; and
a surfactant,
wherein the ink is horizontally discharged to a substrate.

2. The ink according to claim 1,
wherein the two or more types of the organic solvent are water-soluble organic solvent comprises at least one of 1-methoxy-2-propanol, 1-ethoxy-2-propanol, ethylene glycol monomethyl ether, 2-methyl-2-butanol, or 3-methyl-1-butanol, 1-butoxy-2-propanol, ethylene glycol monoethyl ether acetate, ethylene glycol monobutyl ether, or ethylene glycol monomethyl ether acetate.

3. The ink according to claim 1, wherein the two or more types of organic solvents comprise 3-ethyl-3-hydroxymethyl oxetane.

4. The ink according to claim 1,
wherein the two or more types of organic solvent are water-soluble organic solvent comprising ethanol, 1-methoxy-2-propanol, 1-butoxy-2-propanol, and 3-ethyl-3-hydroxymethyl oxetane.

5. The ink according to claim 1,
wherein the two or more types of organic solvents comprise an organic solvent having a boiling point of from 100 to less than 140 degrees C. and an organic solvent having a boiling point of from 140 to 180 degrees C.

6. The ink according to claim 1,
wherein the two or more types of organic solvents comprise an organic solvent having a vapor pressure of from 0.1 to less than 4 mmHg at 25 degrees C. and an organic solvent having a vapor pressure of from 4 to 15 mmHg at 25 degrees C.

7. The ink according to claim 1,
wherein the coloring material comprises a yellow pigment of C.I.Pigment Yellow 110, 74, or 155, a magenta pigment of C.I.Pigment Red 122 or C.I.Pigment Violet 19, a cyan pigment of C.I.Pigment Blue 15:3, a black pigment of C.I.Pigment Black 7, or a white pigment of C.I.Pigment White 6.

8. The ink according to claim 1, wherein the resin comprises an anionic self-emulsifying polyurethane resin.

9. The ink according to claim 1, wherein the resin comprises at least one of an acrylic silicone-based resin or a styrene acrylic resin.

10. The ink according to claim 1, wherein the coloring material comprises a pigment dispersion dispersed by a surfactant and a pigment dispersion covered by a polymer.

11. The ink according to claim 1, wherein the surfactant comprises at least one of a silicone-based surfactant or a nonionic surfactant.

12. A container comprising:
an ink container containing the ink of claim 1.

13. A printing device comprising:
a container containing the ink of claim 1; and
a discharging device configured to horizontally discharge the ink to the substrate.

14. A method of printing comprising:
horizontally discharging the ink of claim 1 to the substrate; and
forming an image on the substrate with the ink attached to the substrate by the discharging.

15. The method according to claim 13, wherein the substrate is made of at least one of metal, glass, synthetic paper, resin, or ceramics.

16. Printed matter comprising:
a substrate; and
a printing layer formed on the substrate by the ink of claim 1 attached to the substrate.

17. The printed matter according to claim 16, wherein the substrate is made of at least one of metal, glass, synthetic paper, resin, or ceramics.
